(19) United States
(12) Patent Application Publication
(10) Pub. No.: US 2025/0385641 A1
(43) Pub. Date: Dec. 18, 2025

(54) VENTILATION DRAINAGE SUPPORT FRAME

(71) Applicant: ZHI-CHENG SHANG, TAICHUNG CITY (TW)

(72) Inventor: ZHI-CHENG SHANG, TAICHUNG CITY (TW)

(21) Appl. No.: 18/948,616

(22) Filed: Nov. 15, 2024

(30) Foreign Application Priority Data
Jun. 13, 2024 (TW) 113121962

(51) Int. Cl. H02S 30/10; E04B 2/56; E04B 5/48; H02S 40/42

(52) U.S. Cl. CPC H02S 30/10; H02S 40/425; E04B 2/56; E04B 5/48

(57) ABSTRACT

A ventilation drainage support frame includes a large-span structure of the frame body formed by longitudinal load-bearing beams and transverse load-bearing beams and a drainage frame formed by transverse drainage rods and longitudinal drainage rods arranged in a rectangular grid. The transverse drainage rods form first channels. The longitudinal drainage rods are positioned above the transverse drainage rods and form second channels. The drainage frame could fix plate bodies. Spaces between the plate bodies are aligned with the first channel and the second channel to facilitate drainage. The longitudinal drainage rods are relatively higher than the transverse drainage rods. Two opposite edges of the plate body abut against the abutted plates of the two longitudinal drainage rods, and the other two opposite edges near the transverse drainage rods are spaced apart by at least one gap, wherein the gap is formed by the height difference between the transverse drainage rods and the longitudinal drainage rods.

### BACKGROUND OF THE INVENTION

### Technical Field

The present invention relates to a modular support frame structure, specifically to a ventilation drainage support frame that offers easy assembly, high structural strength, and integrated drainage and ventilation functions.

### Description of Related Art

Conventional support structures, such as solar panel mounts, canopy brackets, roof frameworks, or wall brackets, typically employ metal frames as the base, over which various panels—such as solar panels, corrugated sheets, aluminum plates, or acrylic boards—are laid. To ensure waterproofing, these panels are assembled on-site through methods such as interlocking installation, stacked assembly, or the use of sealant for gap filling, forming a continuous sealed system. This setup ensures that rainwater drains only from the outermost edge of the assembly. However, when one of the panels sustains localized damage, conventional repair methods could result in visual inconsistencies, compromising the aesthetic integrity of the structure. Replacing a damaged panel requires disassembling part of the original system, which compromises the structural integrity and increases the risk of leakage. Furthermore, the process of disassembly and reassembly is labor-intensive, raising installation complexity and maintenance costs. As a result, conventional fully sealed systems present drawbacks such as difficult maintenance and high repair expenses.

To overcome these limitations, some manufacturers integrate drainage beams along the edges of the panels, enabling segmented drainage through the channels formed by these beams. However, this approach introduces new challenges. Specifically, the drainage beam replaces the load-bearing beam, requiring customization based on the specific installation span. For longer spans, larger drainage beams are necessary, and these dimensions must be determined through engineering calculations or practical experience. This increases the complexity of assembly and necessitates the stocking of multiple beam specifications to accommodate various spans, resulting in logistical inefficiencies by making it impractical to use a single standardized drainage beam for all installations.

Additionally, most canopies, roofs, or wall structures are designed to be airtight to enhance their waterproofing performance. In limited cases, external ventilation devices are installed to introduce breathability. However, these ventilation devices are costly, provide airflow only at specific points, and offer limited ventilation efficiency, making them less adaptable to various structural needs. Consequently, the challenge lies in developing a system that achieves high structural strength while maintaining effective drainage without increasing construction costs or compromising the overall waterproofing performance.

In light of the abovementioned issues, the inventor, drawing from extensive experience in the design, development, and manufacturing of related products, has carefully designed and evaluated a novel solution. This invention offers a practical, cost-effective improvement over existing technologies.

### BRIEF SUMMARY OF THE INVENTION

In view of the above, the primary objective of the present invention is to solve the existing defects of the conventional technique.

The present invention provides a ventilation drainage support frame, including a frame body and a drainage frame. The frame body includes a plurality of columns in a standing position, a plurality of longitudinal load-bearing beams arranged longitudinally across the columns, and a plurality of transverse load-bearing beams arranged transversely across the longitudinal load-bearing beams, wherein the longitudinal load-bearing beams and the transverse load-bearing beams together form the large-span structure of the frame body. The drainage frame includes a plurality of transverse drainage rods and a plurality of longitudinal drainage rods, which are arranged in a rectangular grid, wherein the transverse drainage rods are positioned above the transverse load-bearing beams. Each of the transverse drainage rods forms a first channel in an upward direction. The transverse drainage rods are retracted to form two connecting plates at an opening of the first channel. The longitudinal drainage rods are positioned above the transverse drainage rods, and each of the longitudinal drainage rods forms a second channel in an upward direction. The drainage frame is set for fixing a plurality of plate bodies, and spaces between the plate bodies are aligned with the first channel and the second channel to facilitate drainage. Each of the longitudinal drainage rods is retracted to form two abutted plates at an opening of the second channel, and the abutted plates are relatively higher than the connecting plates of the transverse drainage rods. Two opposite edges of each of the plate bodies abut against the abutted plates of the two longitudinal drainage rods, and the other two opposite edges near the transverse drainage rods are spaced apart by at least one gap, wherein the gap is formed by the height difference between the transverse drainage rods and the longitudinal drainage rods.

In an embodiment, the transverse drainage rods are overlapped on top of the transverse load-bearing beams, and a plurality of connecting assemblies are included for securing the transverse drainage rods and the transverse load-bearing beams. Each of the connecting assemblies includes a connecting seat, a restricting member, a first screw, and a first nut; the connecting seat is in a folded shape and includes a side plate and a top plate. The side plate of the connecting seat is fastened to a side of the transverse load-bearing beam by using a plurality of second screws, and the top plate of the connecting seat presses against the connecting plates of the transverse drainage rod. The top plate of the connecting seat has a perforation. The restricting member is accommodated in the first channel of the transverse drainage rod, and the first screw passes upward through the restricting member and the perforation to screw with the first nut at the top plate of the connecting seat, causing the restricting member and the top plate of the connecting seat to clamp the connecting plates.

In an embodiment, a plurality of clamping assemblies are further included, wherein each of the clamping assemblies includes a base, a third screw, and a pressing member. The base is disposed in the first channel of the transverse drainage rod and abuts the connecting plates, and the pressing member presses down on the plate body. The third screw passes through both the base and the pressing member, thereby clamping the transverse drainage rods and the plate body from two ends.

In an embodiment, each of the clamping assemblies further includes a clamping plate. The clamping plate is passed through by the third screw and is clamped between the connecting plates and the plate body. The clamping plate and the abutted plates form a multi-point support structure for each of the plate bodies.

In an embodiment, a side of the top plate of the connecting seat extends to form a blocking plate, which is parallel to the side plate. The blocking plate and the side plate jointly clamp two sides of the transverse load-bearing beam and the transverse drainage rod.

In an embodiment, the restricting member of each of the connecting assemblies has a positioning hole for passing through by the first screw. The restricting member has two elastic wing portions disposed on two sides of the restricting member that face opposite directions. The two elastic wing portions are curved to provide compression elasticity, and the elastic wing portions of the restricting member elastically urge against the connecting plates of the transverse drainage rod. Each of the two elastic wing portions has a diagonal corner cut, which is formed by recessing at a corner of each of the two elastic wing portions. Since the restricting member has the diagonal corner cuts, the restricting member could be rotated inside the first channel of the transverse drainage rod to a fixed position, and each of the other two sides of the restricting member has a wing plate, wherein the wing plates are non-elastic and abut against the connecting plates of the transverse drainage rod.

In an embodiment, the surrounding of the positioning hole has a plurality of pins, and the first screw has a hexagonal head. When the first screw passes through the positioning hole, the hexagonal head of the first screw contacts with the pins, which drives the restricting member to rotate simultaneously with the first screw.

In an embodiment, the transverse drainage rods have a plurality of restricting notches, which are recessed from the top edges of the transverse drainage rods. The longitudinal drainage rods are set across the transverse drainage rods and are placed into the plurality of restricting notches of each of the transverse drainage rods.

In an embodiment, the ends of the transverse drainage rods are joined end-to-end to form a junction, and a waterproof adhesive is applied to the junction. A joint member is inserted into the first channel of the transverse drainage rods at a site of the junction, wherein the joint member compresses the waterproof adhesive. The joint member extends from the junction toward the middle sections of both transverse drainage rods.

In an embodiment, at a joint site of the two transverse drainage rods, a restricting notch is formed, and the joint member symmetrically extends towards the restricting notch, forming two abutted portions. When each of the longitudinal drainage rods is placed in the restricting notch formed between the two transverse drainage rods, the longitudinal drainage rods press down on the two abutted portions of the joint member.

In an embodiment, the transverse drainage rods are positioned on and transversely across the plurality of transverse load-bearing beams. A plurality of locking assemblies are included for securing the transverse drainage rods and the transverse load-bearing beams. Each of the locking assemblies includes a locking seat, a fixing member, a fourth screw, and a second nut. The locking seat has a cover plate at the center, two base plates at two sides, and two vertical plates connecting the cover plate with the two base plates; the two base plates are on the same plane and are parallel to the cover plate, and each of the two vertical plates is set vertically to connect the cover plate and one of the base plates. The locking seat is fastened to one of the transverse load-bearing beams via the base plates, and the cover plate and the vertical plates enclose one of the transverse drainage rods. The fixing member is accommodated in the first channel of the transverse drainage rod, and the fourth screw passes upward through the fixing member and the cover plate. The fourth screw is screwed into the second nut at the cover plate, so that the fixing member and the locking seat jointly clamp against the connecting plates.

In an embodiment, the frame body is slanted in a direction toward one of two open ends of each of the longitudinal drainage rods, and the lower open end of each of the longitudinal drainage rods is inserted into the first channel of the transverse drainage rod, allowing the water flow in the second channels of the longitudinal drainage rods to be directed into the first channel of the transverse drainage rod. At the sites of each of the longitudinal drainage rods that cross the transverse drainage rods, diversion openings are formed on the longitudinal drainage rods, thereby allowing the water from the second channel of the longitudinal drainage rods to be diverted into multiple first channels of the transverse drainage rods.

In an embodiment, each of the longitudinal drainage rods is cut into a plurality of segmented drainage rods, and the intervals of the segmented drainage rods above the first channels of the transverse drainage rods form the diversion openings.

The primary objective of the present invention is that the frame body is constructed by placing the transverse load-bearing beams transversely across the longitudinal load-bearing beams, forming a large-span structure. This design allows for cutting to specific lengths on-site according to different assembly needs. The transverse drainage rods are overlapped on top of the transverse load-bearing beams, and the connecting assembly is used to quickly assemble the frame body with the drainage frame. This allows both the transverse drainage rods and longitudinal drainage rods of the drainage frame to be assembled without concern for their inherent structural strength. On-site, only cutting to the appropriate length is required for assembly, without concern for whether the drainage frame has sufficient structural strength for use on large-span frames. This approach not only enables the use of a single specification for all large-span frames while achieving the drainage function but also reduces the inventory of drainage frame components and facilitates quick on-site assembly.

The secondary objective of the present invention is that the transverse drainage rods are placed across the transverse load-bearing beams and are secured using multiple locking assemblies. The locking seat is fastened to the transverse load-bearing beams via the base plate, and the transverse drainage rods are enclosed by the cover plate and vertical plate. The fixing member is placed inside the first channel, and the fourth screw passes through the fixing member and the cover plate. The second nut is then threaded onto the fourth screw at the cover plate, clamping the fixing member and the locking seat tightly against the connecting plates. This allows both the transverse drainage rods and longitudinal drainage rods of the drainage frame to be assembled without concern for their structural strength. On-site, only cutting to the required length is necessary for assembly. This design enables the use of a single specification for all large-span brackets, achieving drainage functionality while also reducing the inventory of drainage frame components and allowing for quick on-site assembly.

The third objective of the present invention is the gaps between the plates are aligned with the first channel and second channel, allowing rainwater to flow along the edges of the plates into the first channel and second channel for distributed drainage. This design allows each plate to be independently assembled and drained. If a plate is damaged, the damaged plate could be individually removed and replaced, facilitating maintenance and allowing for different plates to be substituted as needed, offering the advantages of high practicality and high structural strength. Additionally, the gaps could effectively improve ventilation within the frame body without causing water leakage. When applied to roofs or walls, this design could provide effective rain protection, drainage, and ventilation. When used for fences or large billboards, it could reduce wind resistance and enhance structural strength, achieving easy assembly, high structural strength, and ventilation functionality.

Other objectives, advantages, and novel features of this creation will become more apparent from the following detailed description and the accompanying drawings.

### BRIEF DESCRIPTION OF THE SEVERAL VIEWS OF THE DRAWINGS

FIG. 1 is a perspective view of the present invention.

FIG. 2 is an enlarged perspective view of a portion of the present invention.

FIG. 3 is an exploded enlarged perspective view of a portion of the present invention.

FIG. 4 is a sectional view of the longitudinal drainage rod of the present invention.

FIG. 5 is a schematic view, showing the size adjustment of the gap in the present invention.

FIG. 6 is a perspective schematic view, showing the drainage function formed around the periphery of the plate body in the present invention.

FIG. 7 is a partial schematic view, showing the diversion drainage formed by the longitudinal drainage rod in the present invention.

FIG. 8 is an exploded perspective view (1), showing the drainage frame fixed by a connecting assembly in the present invention.

FIG. 9 is an exploded perspective view (2), showing the drainage frame fixed by a connecting assembly in the present invention.

FIG. 10 is a horizontal sectional schematic view, showing the transverse drainage rod of the present invention.

FIG. 11 is a vertical sectional schematic view (1), showing the transverse drainage rod of the present invention.

FIG. 12 is a schematic view, showing the clamping assembly capable of clamping both side plate bodies in the present invention.

FIG. 13 is a schematic view, showing the clamping assembly capable of clamping one plate body in the present invention.

FIG. 14 is a schematic view, showing the transverse drainage rod spanning above the transverse load-bearing beam in the present invention.

FIG. 15 is an exploded perspective view, showing the locking assembly in the present invention.

FIG. 16 is an exploded perspective view, showing the connection of two transverse drainage rods in the present invention.

### DETAILED DESCRIPTION OF THE INVENTION

To provide the esteemed examiner with a comprehensive understanding of the purpose, features, and effects of the present invention, the following detailed description is provided in conjunction with accompanying figures:

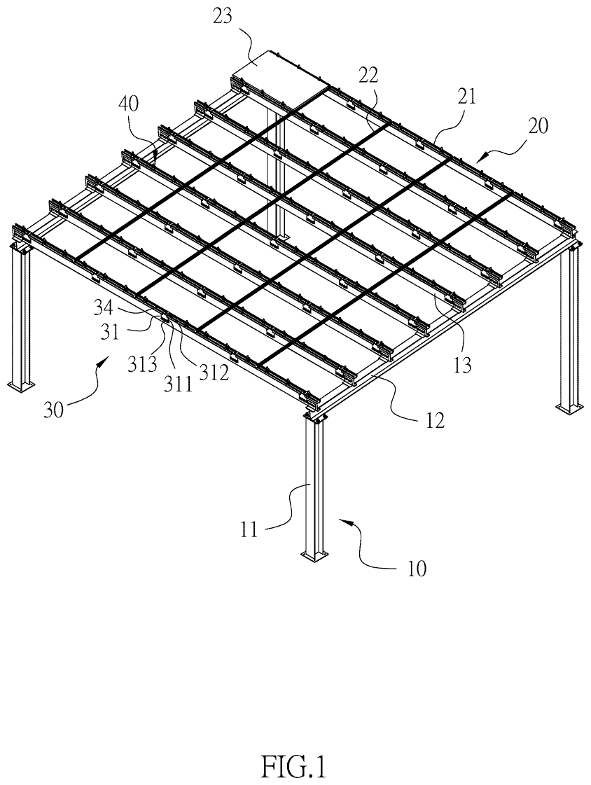

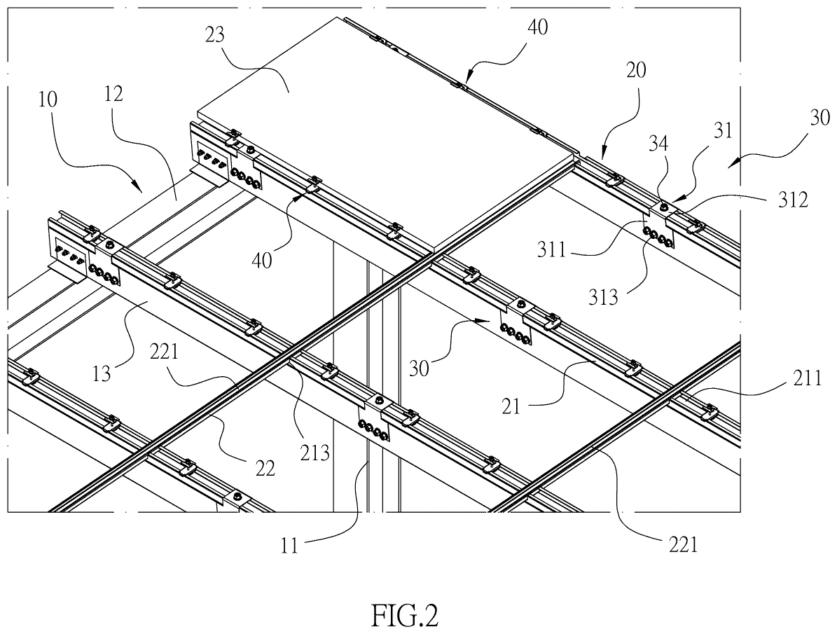

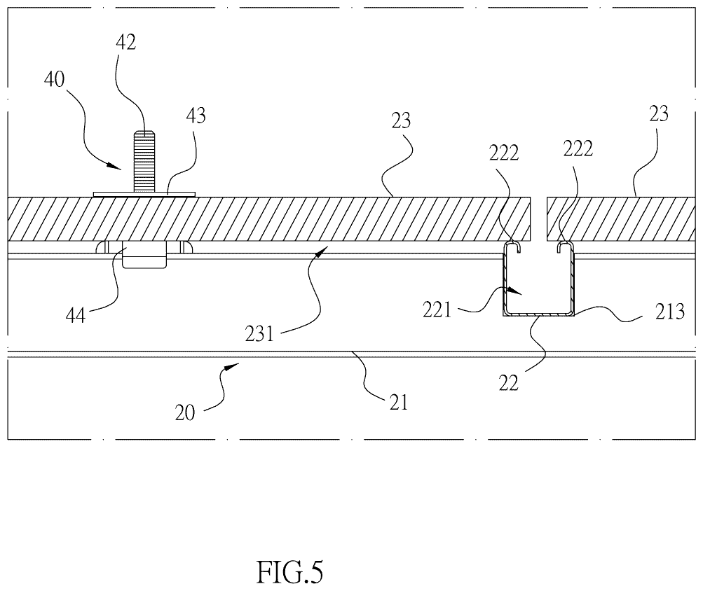

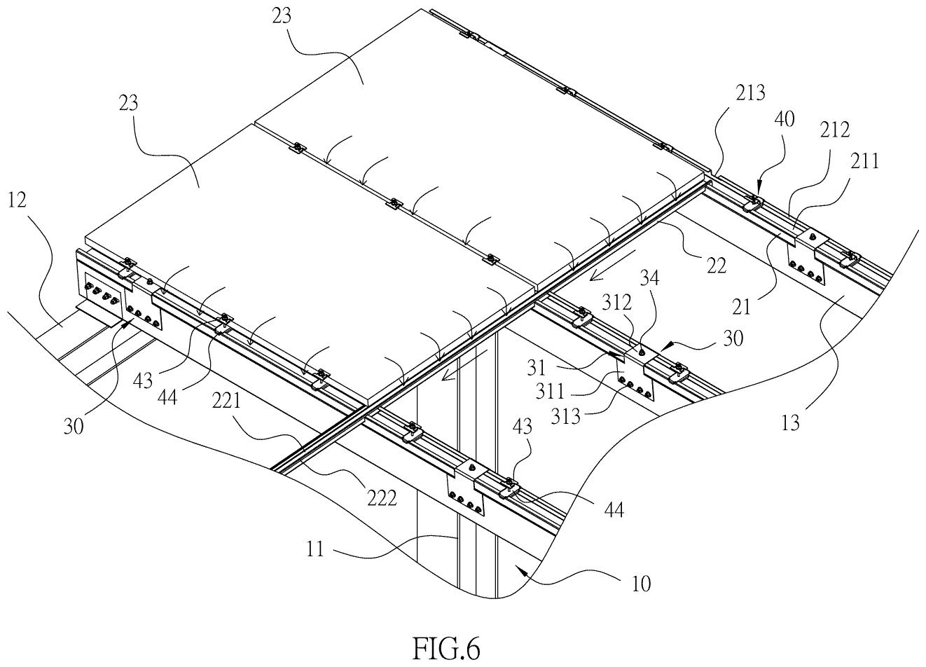

As illustrated in FIG. 1 to FIG. 6, a ventilation drainage support frame including a frame body 10, a drainage frame 20, a plurality of connecting assemblies 30, a plurality of clamping assemblies 40, and a locking assembly 50. The frame body 10 includes a plurality of columns 11 in a standing position, a plurality of longitudinal load-bearing beams 12 arranged longitudinally across the columns 11, and a plurality of transverse load-bearing beams 13 arranged transversely across the longitudinal load-bearing beams 12. The longitudinal load-bearing beams 12 and the transverse load-bearing beams 13 together form the large-span structure of the frame body 10. In other words, the longitudinal load-bearing beams 12 and the transverse load-bearing beams 13 both possess sufficient structural strength, allowing for a large span between the two columns 11. The drainage frame 20 includes a plurality of transverse drainage rods 21 and a plurality of longitudinal drainage rods 22, which are arranged in a rectangular grid. The transverse drainage rods 21 are overlapped and positioned above the transverse load-bearing beams 13. The support provided by the transverse load-bearing beams 13 allows the transverse drainage rods 21 to be mounted on a large-span frame without concern for their own structural strength. Each of the transverse drainage rods 21 forms a first channel 211 in an upward direction. The transverse drainage rods 21 are retracted to form two connecting plates 212 at an opening of the first channel 211. The longitudinal drainage rods 22 are positioned above the transverse drainage rods 21, and each of the longitudinal drainage rods 22 forms a second channel 221 in an upward direction. The drainage frame 20 is set for fixing a plurality of plate bodies 23, and the plate bodies 23 disposed on the frame body 10 serves as a water shield and sunshade. Spaces between the plurality of plate bodies 23 are aligned with the first channel 211 and the second channel 221 to facilitate drainage. Each of the longitudinal drainage rods 22 is retracted to form two abutted plates 222 at an opening of the second channel 221, wherein the abutted plates 222 are relatively higher than the connecting plates 212 of the transverse drainage rods 21. The two opposite edges of each of the plate bodies 23 abut against the abutted plates 222 of the two longitudinal drainage rods 22, while the other two opposite edges near the transverse drainage rods 21 are spaced apart by at least one gap 231. This gap 231 is formed by the height difference between the transverse drainage rods 21 and the longitudinal drainage rods 22. As illustrated in FIG. 5, by utilizing the longitudinal drainage rods 22 with various heights, the size of the gap 231 could be adjusted. The frame body 10 could be combined with different plate bodies 23 could serve as roofs, canopies, walls, floors, pergola tops, solar panels, or other usage. The gap 231 could efficiently enhance the ventilation inside the frame body 10 without water leakage. When the ventilation drainage support frame is applied to the roof or the wall, it provides effective rain protection and drainage and maintains ventilation. When the ventilation drainage support frame is applied to fences or large billboards, it effectively reduces wind resistance, thereby increasing structural strength. This design achieves easy assembly, high structural strength, and ventilation functionality.

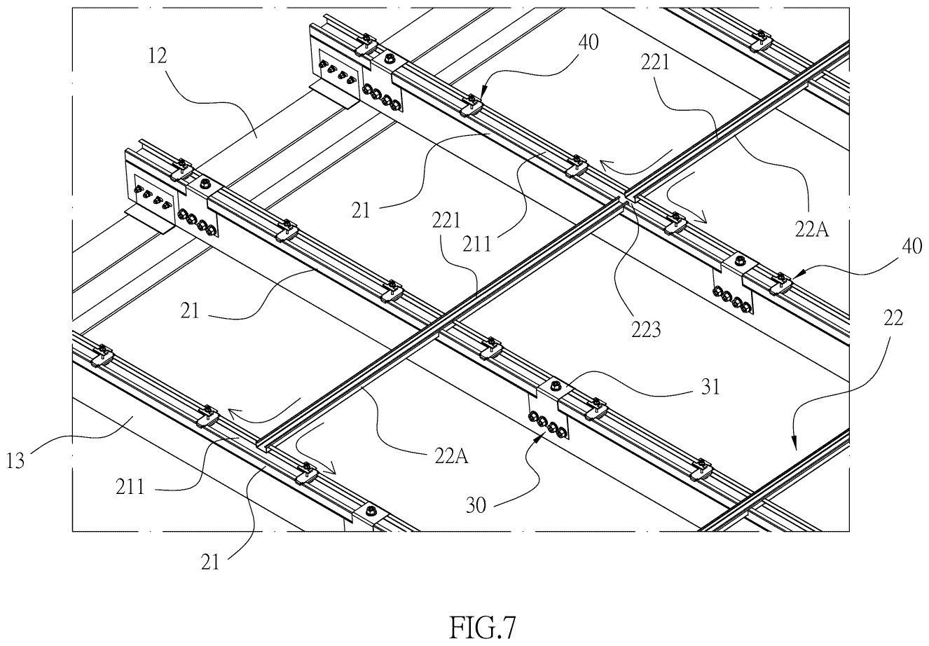

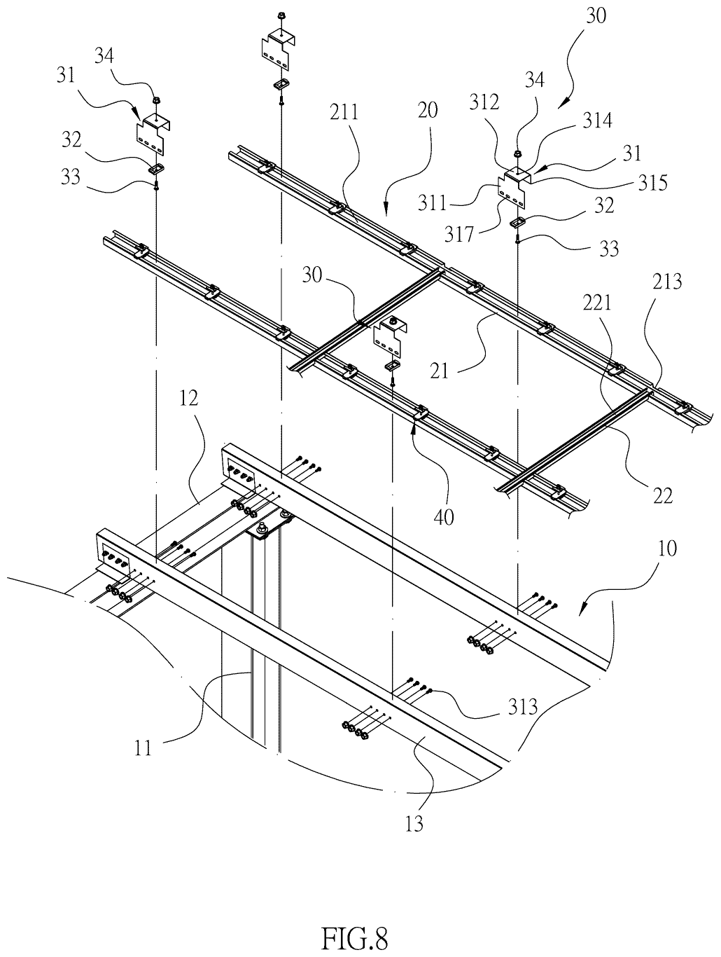

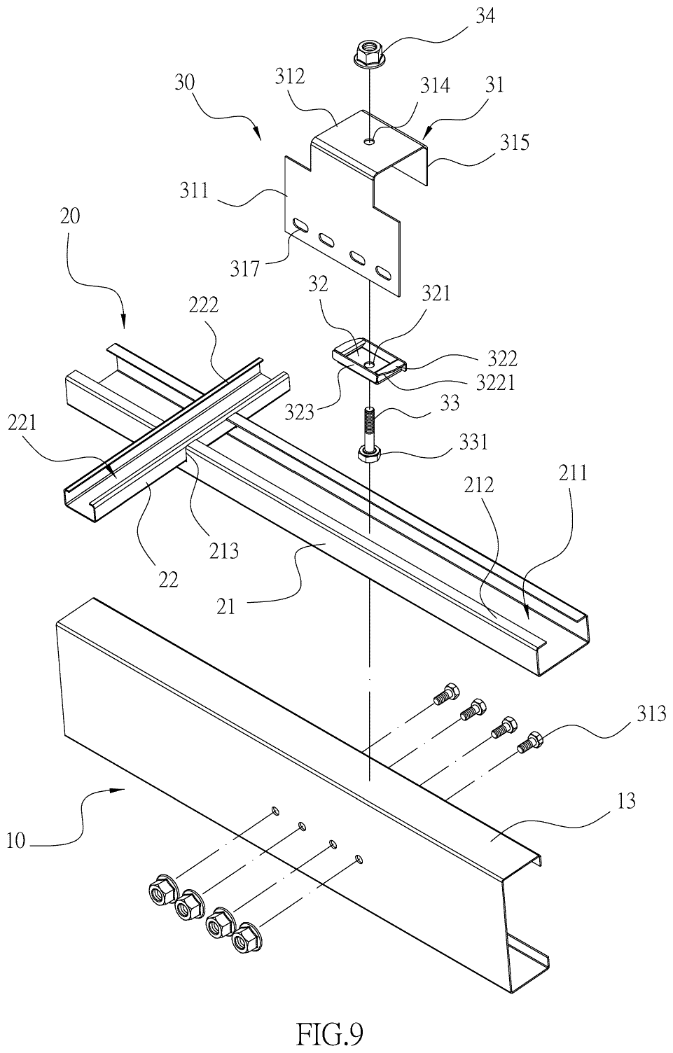

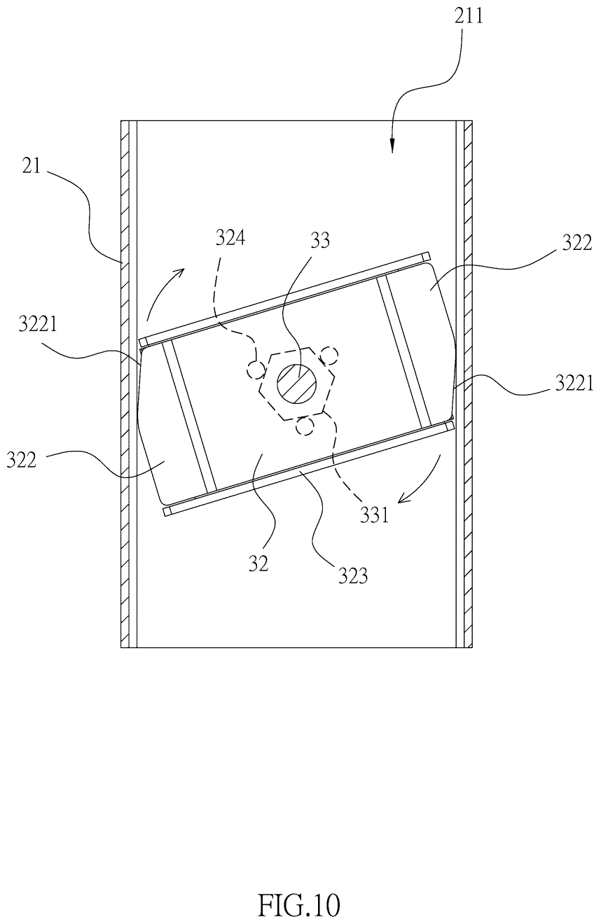

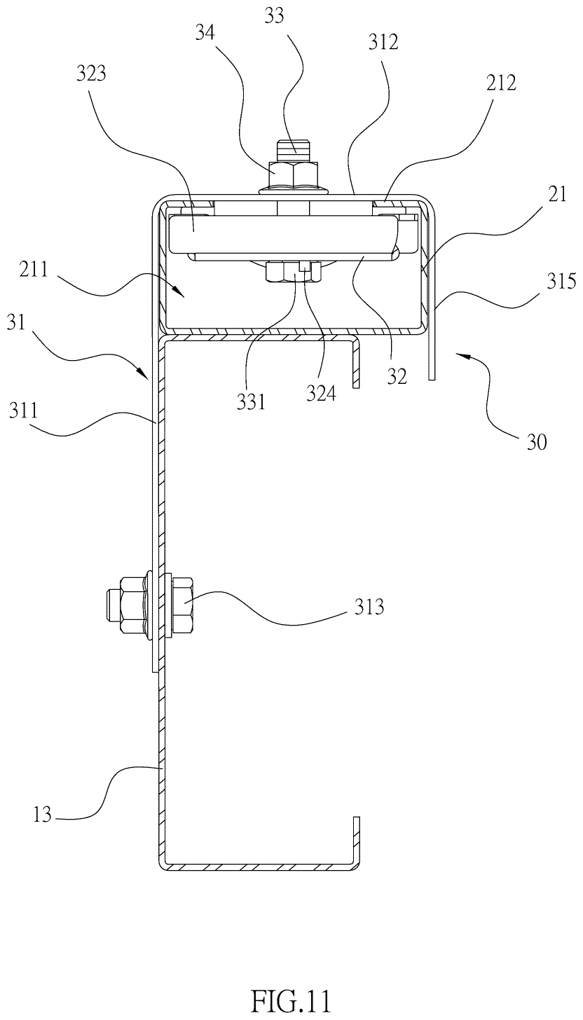

As illustrated in FIG. 7 to FIG. 11, a plurality of the connecting assembly 30 includes a connecting seat 31, a restricting member 32, a first screw 33, and a first nut 34. The connecting seat 31 is in a folded shape and includes a side plate 311 and a top plate 312. The side plate 311 of the connecting seat 31 is fastened to the side of the transverse load-bearing beam 13 by using a plurality of second screws 313, and the top plate 312 of the connecting seat 31 presses against the connecting plates 212 of the transverse drainage rod 21. The top plate 312 of the connecting seat 31 has a perforation 314. The restricting member 32 is accommodated in the first channel 211 of transverse drainage rod 21, and the first screw 33 passes upward through the restricting member 32 and the perforation 314 to screw with the first nut 34 at the top plate 312 of the connecting seat 31, causing the restricting member 32 and the top plate 312 of the connecting seat 31 to clamp the connecting plates 212.

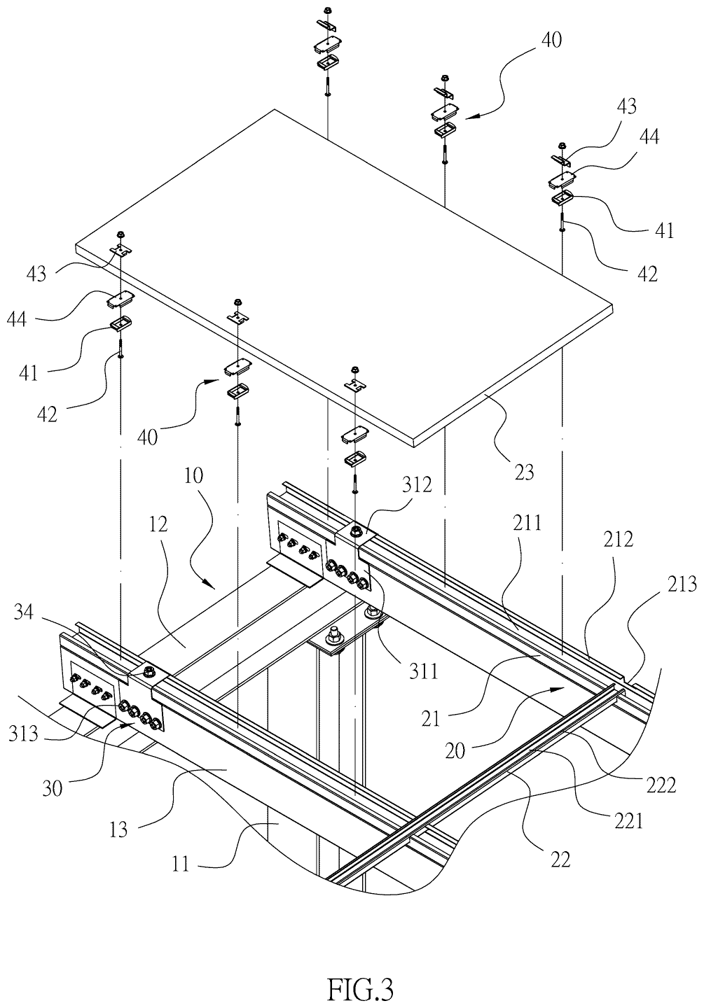

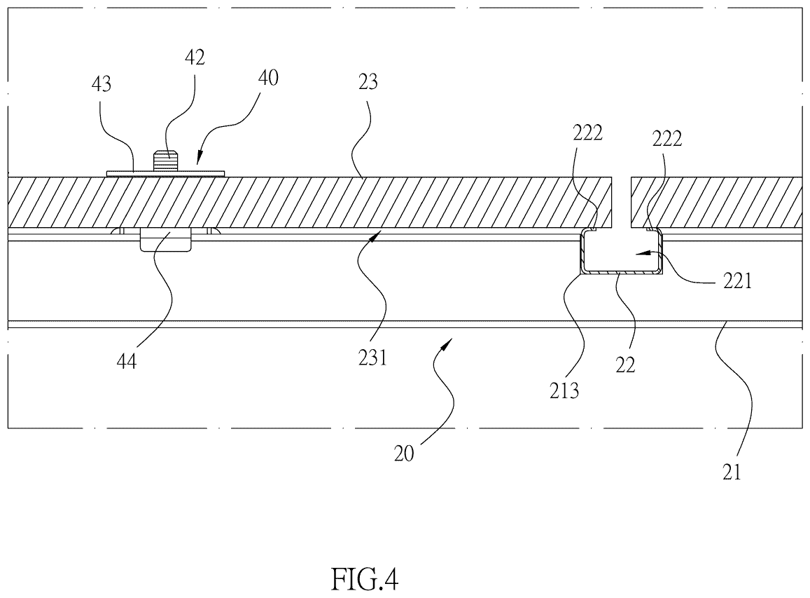

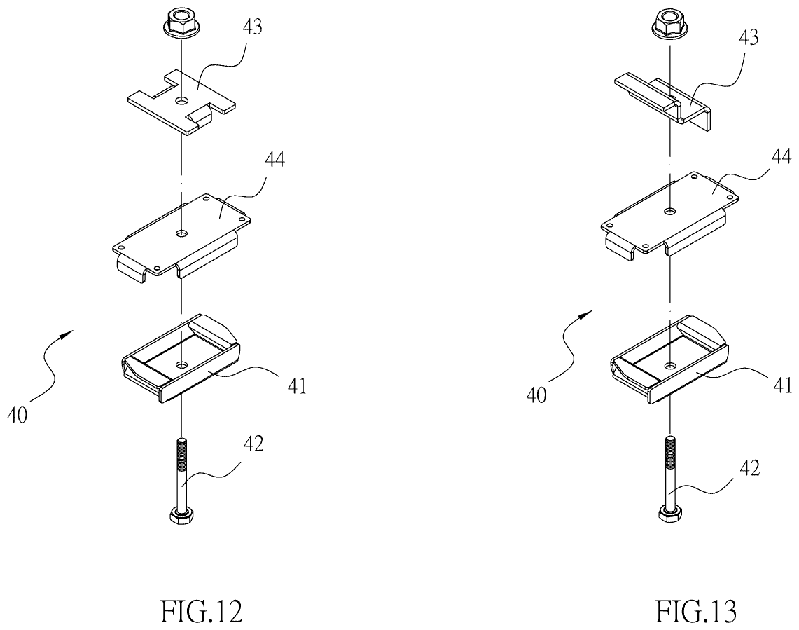

As illustrated in FIG. 3, FIG. 4, FIG. 12, and FIG. 13, the drainage frame 20 includes a plurality of clamping assemblies 40, wherein each of the clamping assemblies 40 includes a base 41, a third screw 42, and a pressing member 43. The base 41 is disposed in the first channel 211 of the transverse drainage rod 21 and abuts the connecting plates 212, and the pressing member 43 presses down on the plate body 23. The third screw 42 passes through both the base 41 and the pressing member 43, thereby clamping the transverse drainage rods 21 and the plate body 23 from two ends. The transverse drainage rods 21 have a plurality of restricting notches 213, which are recessed from top edges of the transverse drainage rods 21. The longitudinal drainage rods 22 are set across the transverse drainage rods 21, placed into the plurality of restricting notches 213 of each of the transverse drainage rods 21, thereby quickly fastening the longitudinal drainage rods 22. Moreover, the transverse drainage rods 21 and the longitudinal drainage rods 22 form an interlocking grid structure, which significantly improves the torsional resistance of the drainage frame 20, thereby preventing the frame body 10 and the drainage frame 20 from torsional deformation. The clamping assembly 40 further includes a clamping plate 44. The clamping plate 44 is passed through by the third screw 42 and is clamped between the connecting plates 212 and the plate body 23. The clamping plate 44 and the abutted plates 222 form a multi-point support structure for each of the plate bodies 23.

Furthermore, as illustrated in FIG. 7 to FIG. 11, the restricting member 32 has two elastic wing portions 322 disposed on two sides that face opposite directions. Each of the two elastic wing portions 322 has a diagonal corner cut 3221, which is formed by recessing at a corner of each of the two elastic wing portions 322. Since the restricting member 32 has the diagonal corner cuts 3221 design, the restricting member 32 could be rotated in the first channel 211 of the transverse drainage rod 21 to a fixed position. In other words, the restricting member 32 could be directly put into the first channel 211 of the transverse drainage rod 21 without changing the orientation of the restricting member 32 and then be rotated 90 degrees to fix in the transverse drainage rods 21 by fitting with the transverse drainage rods 21, enabling quick fastening. The restricting member 32 has a positioning hole 321, wherein the surrounding of the positioning hole 321 has a plurality of pins 324. The first screw 33 has a hexagonal head 331. When the first screw 33 passes through the positioning hole 321, the hexagonal head 331 contacts with the pins 324 which drives the restricting member 32 to rotate simultaneously with the first screw 33, enabling quick fastening. Additionally, the elastic wing portions 322 are curved to provide compression elasticity, and the elastic wing portions 322 of the restricting member 32 elastically urge against the connecting plates 212 of the transverse drainage rod 21. Each of the other two sides of the restricting member 32 has a wing plate 323, wherein the wing plates 323 are non-elastic and abut against the connecting plates 212 of the transverse drainage rods 21. This configuration allows the elastic wing portions 322 to elastically press against the structure, making the first nut 34 less likely to loosen, while the non-elastic wing plates 323 increase the connection strength, thereby achieving stable assembly. As illustrated in FIG. 7, the frame body 10 is slanted in a direction toward one of two open ends of the longitudinal drainage rods 22, and the lower open end of the longitudinal drainage rods 22 is inserted into the first channel 211 of the transverse drainage rod 21, allowing the water flow in the second channels 221 of the longitudinal drainage rods 22 to be directed into the first channel 211 of the transverse drainage rod 21. At the sites of each of the longitudinal drainage rods 22 that cross the transverse drainage rods 21, diversion openings 223 are formed, thereby allowing the water from the second channel 221 of the longitudinal drainage rod 22 to be diverted into multiple first channels 211 of the transverse drainage rods 21. Each of the longitudinal drainage rods 22 is cut into a plurality of segmented drainage rods 22A, and the intervals of the segmented drainage rods 22A above the first channels 211 of the transverse drainage rods 21 form the diversion openings 223, thereby achieving the effect of distributed drainage without compromising structural strength.

A side of the top plate 312 of the connecting seat 31 extends to form a blocking plate 315, which is parallel to the side plate 311. The blocking plate 315 and the side plate 311 jointly clamp two sides of the transverse load-bearing beams 13 and the transverse drainage rods 21, ensuring that the transverse drainage rods 21 stably press down on the transverse load-bearing beams 13. In summary, the connecting seat 31, with its side plate 311, top plate 312, and blocking plate 315, securely encloses the transverse load-bearing beams 13 and the transverse drainage rods 21. Additionally, the second screws 313 fasten the side plate 311 to the transverse load-bearing beams 13. The restricting member 32 and the top plate 312 tightly clamp the connecting plates 212 by utilizing the first screw 33 and first nut 34, thereby securing the top plate 312 and the transverse drainage rods 21. Such design allows for quick assembly of the transverse load-bearing beams 13 and the transverse drainage rods 21 without damaging the transverse drainage rods 21, thereby ensuring both assembly strength and durability.

As illustrated in FIG. 1 to FIG. 6, the longitudinal load-bearing beams 12 transversely across the longitudinal load-bearing beams 12 to form the large-span structure of the frame body 10, allowing for the frame to be cut to specific lengths on-site according to various assembly requirements. The transverse drainage rods 21 are overlapped on top of the transverse load-bearing beams 13, and the connecting assembly 30 allows for quick assembly of the frame body 10 with the drainage frame 20. This combination allows the transverse drainage rods 21 and longitudinal drainage rods 22 of the drainage frame 20 to be assembled without concern for their own structural strength, so that the drainage frame 20 could be prepared by cutting unified, low-cost, small-sized C-shaped steel components into the required length on-site for assembly. There is no need to worry about whether the drainage frame 20 has sufficient structural strength for use with large-span frame. As a result, a single specification of steel components could be applied to all large-span frame, achieving the goal of drainage and also reducing the inventory of drainage frame 20 components and facilitating quick on-site assembly. Additionally, this design is more flexible for replacing the top plate or solar panels on old frames. The drainage frame 20 utilizes the transverse drainage rods 21 directly overlapped on the transverse load-bearing beams 13, and the connecting assembly 30 enables stable assembly without damaging the transverse drainage rods 21, which allows a single specification of the drainage frame 20 to be compatible with any specification of old frames, thereby significantly enhancing the practicality.

Furthermore, spaces between the plate bodies 23 are aligned with the first channel 211 and the second channel 221, so that rainwater could flow along the edges of the plate bodies 23 into the first channel 211 and the second channel 221 for distributed drainage. With such a design, each of the plate bodies 23 is independently assembled and drained. When a single plate body 23 is damaged, the damaged plate body could be individually removed and replaced, which is beneficial for subsequent maintenance and allows for the replacement of different plate bodies 23 based on specific needs. As a result, the present invention has the advantages of both high practicality and high structural strength. On the other sides, the present invention also effectively overcomes erosion corrosion, because the first channel 211 and the second channel 221 are in the shape of long-groove that allows the rainwater to be directly drained. Erosion corrosion usually occur when dirty liquids or liquids containing suspended particles flow turbulently or at high speeds, and it is more severe when there is a change in the flow direction or impact. Since the liquid is directly drained in a straight path in the present invention, the drawbacks of erosion corrosion could be prevented.

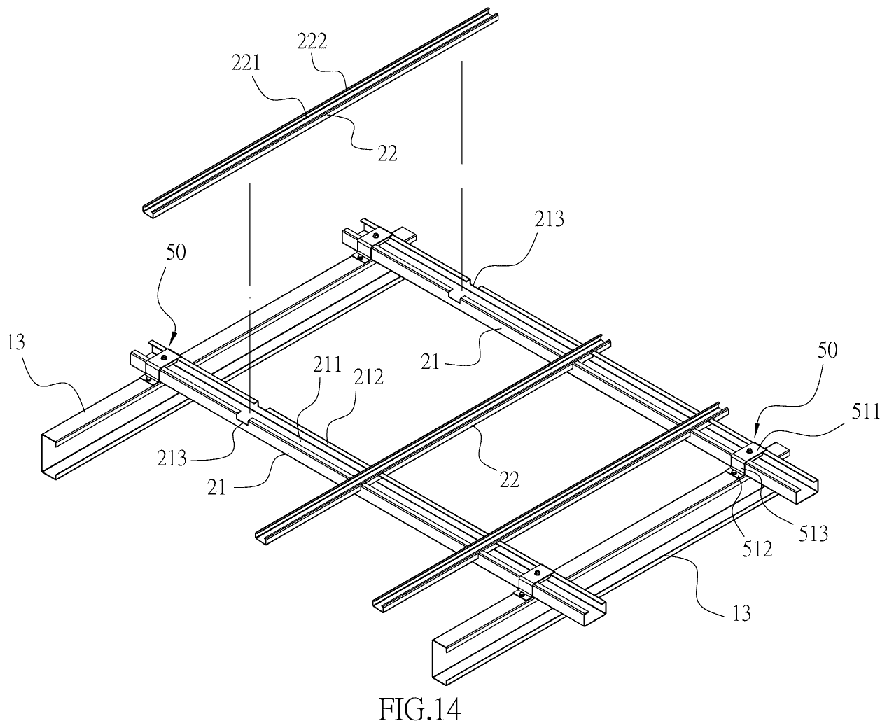

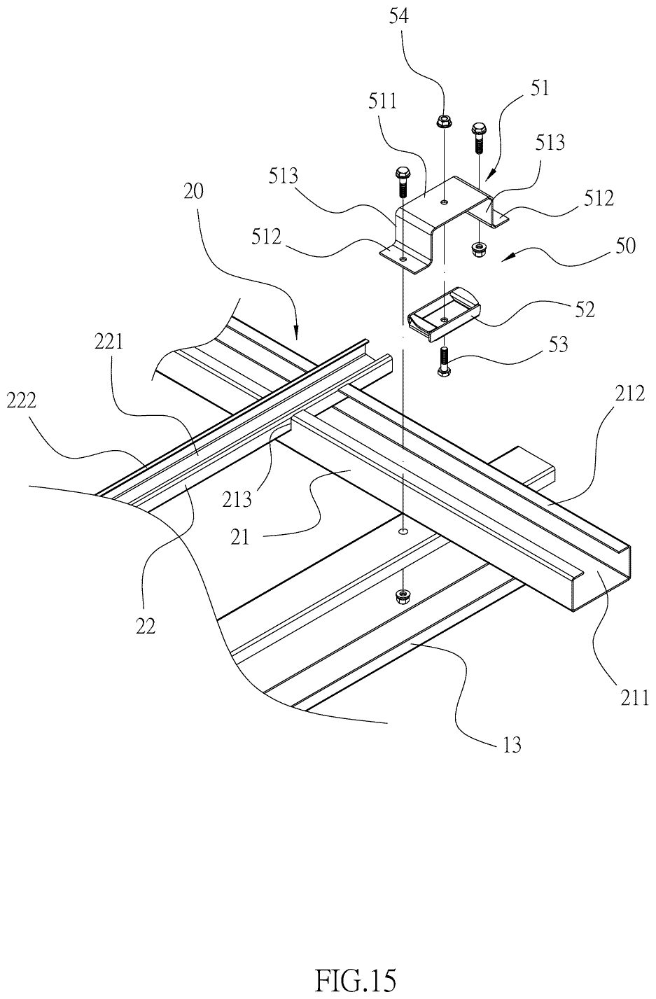

In another embodiment, as illustrated in FIG. 14 and FIG. 15, the frame body 10 includes a plurality of columns 11 in a standing position. A plurality of longitudinal load-bearing beams 12 arranged longitudinally across the columns 11, and a plurality of transverse load-bearing beams 13 arranged transversely across the longitudinal load-bearing beams 12. The longitudinal load-bearing beams 12 and the transverse load-bearing beams 13 together form the large-span structure of the frame body 10. The transverse drainage rods 21 are positioned on and transversely across the plurality of transverse load-bearing beams 13, wherein the plurality of locking assemblies 50 are utilized to fix the transverse drainage rods 21 and the transverse load-bearing beams 13. Each of the locking assemblies 50 includes a locking seat 51, a fixing member 52, a fourth screw 53, and a second nut 54. The locking seat 51 has a cover plate 511 at the center, two base plates 512 at two sides, and two vertical plates 513 connecting the cover plate 511 with the two base plates 512. The two base plates 512 are on the same plane and are parallel to the cover plate 511, and each of the two vertical plates 513 is set vertically to connect the cover plate 511 and one of the base plates 512. The locking seat 51 is fastened to one of the transverse load-bearing beams 13 via the base plates 512, and the cover plate 511 and the vertical plates 513 enclose one of the transverse drainage rods 21. The fixing member 52 is accommodated in the first channel 211 of the transverse drainage rod 21, and the fourth screw 53 passes upward through the fixing member 52 and the cover plate 511. The fourth screw 53 is screwed into the second nut 54 at the cover plate 511, so that the fixing member 52 and the locking seat 51 tightly abut against the connecting plates 212. This configuration allows for quick assembly with the transverse load-bearing beams 13 without damaging the transverse drainage rods 21, ensuring both assembly strength and durability.

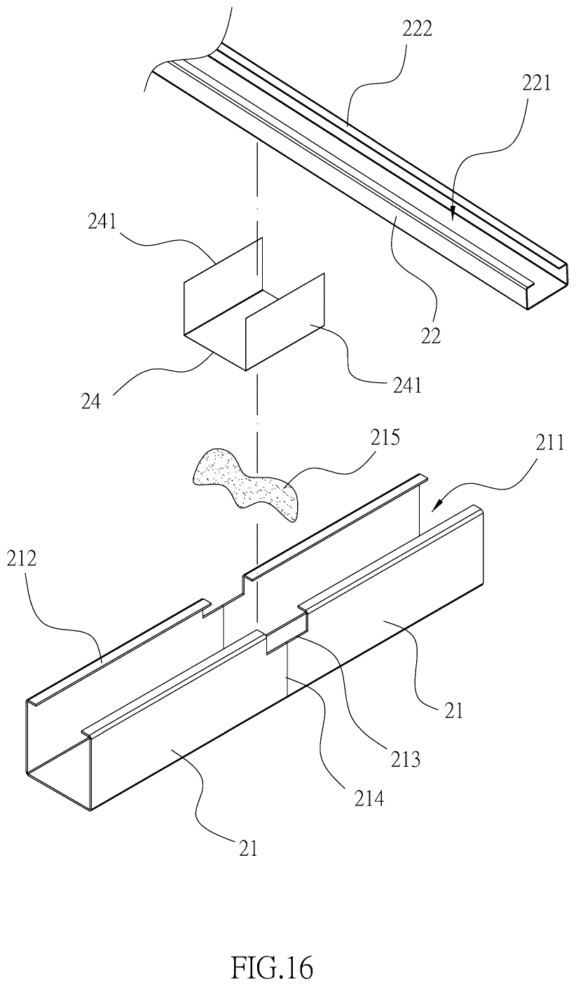

In another embodiment, as illustrated in FIG. 16, when the frame bodies 10 are continuously extended, the ends of the transverse drainage rods 21 from different frame bodies 10 are joined end-to-end, forming junctions 214, wherein a waterproof adhesive 215 is applied to each of the junctions 214. A joint member 24 is inserted into the first channel 211 at a site of each of the junctions 214, wherein the joint member 24 compresses the waterproof adhesive 215. The joint member 24 extends from one of the junctions 214 toward the middle sections of both transverse drainage rods 21, effectively extending the first channel 211 and achieving a waterproofing effect. At the joint site of the two transverse drainage rods 21, a restricting notch 213 is formed. The joint member 24 symmetrically extends towards the restricting notch 213, forming two abutted portions 241. When the longitudinal drainage rods 22 are placed in the restricting notch 213 formed between the two transverse drainage rods 21, the longitudinal drainage rods 22 press down on the two abutted portions 241 of the joint member 24, thereby enhancing the structural strength at the joint. This effectively prevents the two transverse drainage rods 21 from separating or misaligning at the joint site.

It must be pointed out that the embodiment described above is only a preferred embodiment of the present invention. It is understood that the present invention is not limited to these examples and embodiments. All equivalent structures and methods that employ the concepts disclosed in this specification and the appended claims should fall within the scope of the present invention.

What is claimed is:

1. A ventilation drainage support frame, comprising:
a frame body comprising a plurality of columns in a standing position, a plurality of longitudinal load-bearing beams arranged longitudinally across the columns, and a plurality of transverse load-bearing beams arranged transversely across the longitudinal load-bearing beams, wherein the longitudinal load-bearing beams and the transverse load-bearing beams together form the large-span structure of the frame body;
a drainage frame comprising a plurality of transverse drainage rods and a plurality of longitudinal drainage rods, which are arranged in a rectangular grid, wherein the transverse drainage rods are positioned above the transverse load-bearing beams, and each of the transverse drainage rods forms a first channel in an upward direction; the transverse drainage rods are retracted to form two connecting plates at an opening of the first channel; the longitudinal drainage rods are positioned above the transverse drainage rods, and each of the longitudinal drainage rods forms a second channel in an upward direction; the drainage frame is set for fixing a plurality of plate bodies, and spaces between the plate bodies are aligned with the first channel and the second channel to facilitate drainage;
wherein each of the longitudinal drainage rods is retracted to form two abutted plates at an opening of the second channel, and the abutted plates are relatively higher than the connecting plates of the transverse drainage rods; two opposite edges of each of the plate bodies abut against the abutted plates of the two longitudinal drainage rods, and the other two opposite edges near the transverse drainage rods are spaced apart by at least one gap, wherein the gap is formed by the height difference between the transverse drainage rods and the longitudinal drainage rods.

2. The ventilation drainage support frame as claimed in claim 1, wherein the transverse drainage rods are overlapped on top of the transverse load-bearing beams, and a plurality of connecting assemblies are comprised for securing the transverse drainage rods and the transverse load-bearing beams; each of the connecting assemblies comprises a connecting seat, a restricting member, a first screw, and a first nut; the connecting seat is in a folded shape and comprises a side plate and a top plate; the side plate of the connecting seat is fastened to a side of the transverse load-bearing beam by using a plurality of second screws, and the top plate of the connecting seat presses against the connecting plates of the transverse drainage rod; the top plate of the connecting seat has a perforation; the restricting member is accommodated in the first channel of the transverse drainage rod, and the first screw passes upward through the restricting member and the perforation to screw with the first nut at the top plate of the connecting seat, causing the restricting member and the top plate of the connecting seat to clamp the connecting plates.

3. The ventilation drainage support frame as claimed in claim 2, further comprising a plurality of clamping assemblies, wherein each of the clamping assemblies comprises a base, a third screw, and a pressing member; the base is disposed in the first channel of the transverse drainage rod and abuts the connecting plates, and the pressing member presses down on the plate body; the third screw passes through both the base and the pressing member, thereby clamping the transverse drainage rods and the plate body from two ends.

4. The ventilation drainage support frame as claimed in claim 3, wherein each of the clamping assemblies further comprises a clamping plate; the clamping plate is passed through by the third screw and is clamped between the connecting plates and the plate body; the clamping plate and the abutted plates form a multi-point support structure for each of the plate bodies.

5. The ventilation drainage support frame as claimed in claim 2, wherein a side of the top plate of the connecting seat extends to form a blocking plate, which is parallel to the side plate; the blocking plate and the side plate jointly clamp two sides of the transverse load-bearing beam and the transverse drainage rod.

6. The ventilation drainage support frame as claimed in claim 2, wherein the restricting member of each of the connecting assemblies has a positioning hole for passing through by the first screw; the restricting member has two elastic wing portions disposed on two sides of the restricting member that face opposite directions; the two elastic wing portions are curved to provide compression elasticity, and the elastic wing portions of the restricting member elastically urge against the connecting plates of the transverse drainage rod; each of the two elastic wing portions has a diagonal corner cut, which is formed by recessing at a corner of each of the two elastic wing portions; since the restricting member has the diagonal corner cuts, the restricting member could be rotated inside the first channel of the transverse drainage rod to a fixed position, and each of the other two sides of the restricting member has a wing plate, wherein the wing plates are non-elastic and abut against the connecting plates of the transverse drainage rod.

7. The ventilation drainage support frame as claimed in claim 2, wherein the surrounding of the positioning hole has a plurality of pins, and the first screw has a hexagonal head; when the first screw passes through the positioning hole, the hexagonal head of the first screw contacts with the pins, which drives the restricting member to rotate simultaneously with the first screw.

8. The ventilation drainage support frame as claimed in claim 1, wherein the transverse drainage rods have a plurality of restricting notches, which are recessed from top edges of the transverse drainage rods; the longitudinal drainage rods are set across the transverse drainage rods and are placed into the plurality of restricting notches of each of the transverse drainage rods.

9. The ventilation drainage support frame as claimed in claim 8, wherein the ends of the transverse drainage rods are joined end-to-end to form a junction, and a waterproof adhesive is applied to the junction; a joint member is inserted into the first channel of the transverse drainage rods at a site of the junction, wherein the joint member compresses the waterproof adhesive, and the joint member extends from the junction toward middle sections of both transverse drainage rods.

10. The ventilation drainage support frame as claimed in claim 9, wherein at a joint site of the two transverse drainage rods, a restricting notch is formed, and the joint member symmetrically extends towards the restricting notch, forming two abutted portions; when each of the longitudinal drainage rods is placed in the restricting notch formed between the two transverse drainage rods, the longitudinal drainage rods press down on the two abutted portions of the joint member.

11. The ventilation drainage support frame as claimed in claim 1, wherein the transverse drainage rods are positioned on and transversely across the plurality of transverse load-bearing beams; a plurality of locking assemblies are comprised for securing the transverse drainage rods and the transverse load-bearing beams; each of the locking assemblies comprises a locking seat, a fixing member, a fourth screw, and a second nut; the locking seat has a cover plate at the center, two base plates at two sides, and two vertical plates connecting the cover plate with the two base plates; the two base plates are on the same plane and are parallel to the cover plate, and each of the two vertical plates is set vertically to connect the cover plate and one of the base plates; the locking seat is fastened to one of the transverse load-bearing beams via the base plates, and the cover plate and the vertical plates enclose one of the transverse drainage rods; the fixing member is accommodated in the first channel of the transverse drainage rod, and the fourth screw passes upward through the fixing member and the cover plate; the fourth screw is screwed into the second nut at the cover plate, so that the fixing member and the locking seat jointly clamp against the connecting plates.

12. The ventilation drainage support frame as claimed in claim 1, wherein the frame body is slanted in a direction toward one of two open ends of each of the longitudinal drainage rods, and the lower open end of each of the longitudinal drainage rods is inserted into the first channel of the transverse drainage rod, allowing the water flow in the second channels of the longitudinal drainage rods to be directed into the first channel of the transverse drainage rod; at the sites of each of the longitudinal drainage rods that cross the transverse drainage rods, diversion openings are formed on the longitudinal drainage rods, thereby allowing the water from the second channel of the longitudinal drainage rods to be diverted into multiple first channels of the transverse drainage rods.

13. The ventilation drainage support frame as claimed in claim 12, wherein each of the longitudinal drainage rods is cut into a plurality of segmented drainage rods, and the intervals of the segmented drainage rods above the first channels of the transverse drainage rods form the diversion openings.
